(19) United States
(12) Patent Application Publication
(10) Pub. No.: US 2025/0203679 A1
(43) Pub. Date: Jun. 19, 2025

(54) ELEVATOR RELATED COMMUNICATION SERVICE

(71) Applicant: KONE Corporation, Helsinki (FI)

(72) Inventor: Johanna MANNINEN, Helsinki (FI)

(73) Assignee: KONE Corporation, Helsinki (FI)

(21) Appl. No.: 19/071,045

(22) Filed: Mar. 5, 2025

Related U.S. Application Data
(63) Continuation of application No. PCT/FI2022/050680, filed on Oct. 12, 2022.

(51) Int. Cl. H04W 76/10; B66B 3/00; H04W 4/38

(52) U.S. Cl. CPC H04W 76/10; B66B 3/002; H04W 4/38

(57) ABSTRACT

A method associates a user of a terminal device to at least one communication service providing information on an operating state of an elevator. The method includes: receiving a request; directing the terminal device to access a network service of the elevator; providing a number of options for selecting at least one communication service for providing information; in response to a receipt of an indication of the at least one selected communication service associating the user of the terminal device to receive access information on the operating state of the elevator through the at least one selected communication service. Also a control system and a computer readable medium storing program are provided.

### TECHNICAL FIELD

The invention concerns in general the technical field of elevators. More particularly, the invention concerns a communication environment for users of an elevator.

### BACKGROUND

Customers acquiring an elevator system may be provided with access to some online services hosted by the manufacturer of the elevator system. The access to the online services is restricted, and the information communicated over the online service typically relate to an operation on the elevator systems and maintenance aspects of them. The parties provided with the access to the online services are typically facility managers, building owners, etc.

On the other hand there are introduced solutions for enabling communications between inhabitants and/or visitors in a building by arranging display screens in the building, such as in an elevator car, into which it is possible to send messages. Such a solution is disclosed in a document US 2018/0287970 A1.

In addition to the existing solutions there is room for introducing novel approaches which improve sharing of information in a context of elevators.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An object of the invention is to present a method, a control system and a computer program for associating a user to a communication service.

The objects of the invention are reached by a method, a control system and a computer program as defined by the respective independent claims.

According to a first aspect, a method for associating a user of a terminal device to at least one communication service providing information on an operating state of an elevator is provided to, the method, performed by a control system, comprises:
receiving a request from the terminal device,
directing the terminal device to access a network service of the elevator defined by data carried in the request,
providing a number of options for selecting at least one communication service for providing information on the operating state of the elevator,
in response to a receipt of an indication of the at least one selected communication service associating the user of the terminal device to access information on the operating state of the elevator through the at least one selected communication service.

The method may further comprise a step of:
detecting, prior to directing the terminal device to access the network service, that the request is received from a communication network provided by the elevator.

For example, the number of options for selecting the at least one communication service may correspond to communication services the elevator is provided with an account.

Alternatively or in addition, the method may further comprise:
inquiring, from the terminal device, information on the at least one communication service accessible by the user of the terminal device.

The number of options provided for selecting may be defined based on the information on the at least one communication service accessible by the user of the terminal device.

The associating the user of the terminal device to access the information on the operating state of the elevator through the at least one selected communication service may e.g. be arranged by generating a control signal to add the user of the terminal device to a group of the communication service dedicated to the elevator. For example, data descriptive of an access right level to contribute in the group of the communication service dedicated to the elevator may be defined for a user of the terminal device. The access right level may e.g. be inquired from a data storage and be delivered to the at least one communication service the user of the terminal device is associated to.

According to a second aspect, a control system for associating a user of a terminal device to at least one communication service providing information on an operating state of an elevator is provided, the control system configured to:
receive a request from the terminal device,
direct the terminal device to access a network service of the elevator defined by data carried in the request,
provide a number of options for selecting at least one communication service for providing information on the operating state of the elevator,
in response to a receipt of an indication of the at least one selected communication service associate the user of the terminal device to access information on the operating state of the elevator through the at least one selected communication service.

The control system may further be configured to:
detect, prior to directing the terminal device to access the network service, that the request is received from a communication network provided by the elevator.

For example, the control system may be configured to instruct to provide the number of options for selecting the at least one communication service to correspond to communication services the elevator is provided with an account.

Moreover, the control system may further be configured to:
inquire, from the terminal device, information on the at least one communication service accessible by the user of the terminal device.

The control system may e.g. be configured to define the number of options provided for selecting based on the information on the at least one communication service accessible by the user of the terminal device.

The control system may also be configured to arrange the associating the user of the terminal device to access the information on the operating state of the elevator through the at least one selected communication service by generating a control signal to add the user of the terminal device to a group of the communication service dedicated to the elevator. The control system may be configured to define data descriptive of an access right level to contribute in the group of the communication service dedicated to the elevator for a user of the terminal device. Further, the control system may be configured to inquire the access right level from a data storage and to deliver it to the at least one communication service the user of the terminal device is associated to.

According to a third aspect, a computer program comprising instructions which, when the program is executed by a computer, cause the computer to carry out the steps of the method according to the first aspect as defined above.

The expression “a number of” refers herein to any positive integer starting from one, e.g. to one, two, or three.

The expression “a plurality of” refers herein to any positive integer starting from two, e.g. to two, three, or four.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically a system according to an example.

FIG. 2 illustrates schematically a method according to an example.

FIG. 3 illustrates schematically a control system according to an example.

### DESCRIPTION OF THE EXEMPLIFYING EMBODIMENTS

The specific examples provided in the description given below should not be construed as limiting the scope and/or the applicability of the appended claims. Lists and groups of examples provided in the description given below are not exhaustive unless otherwise explicitly stated.

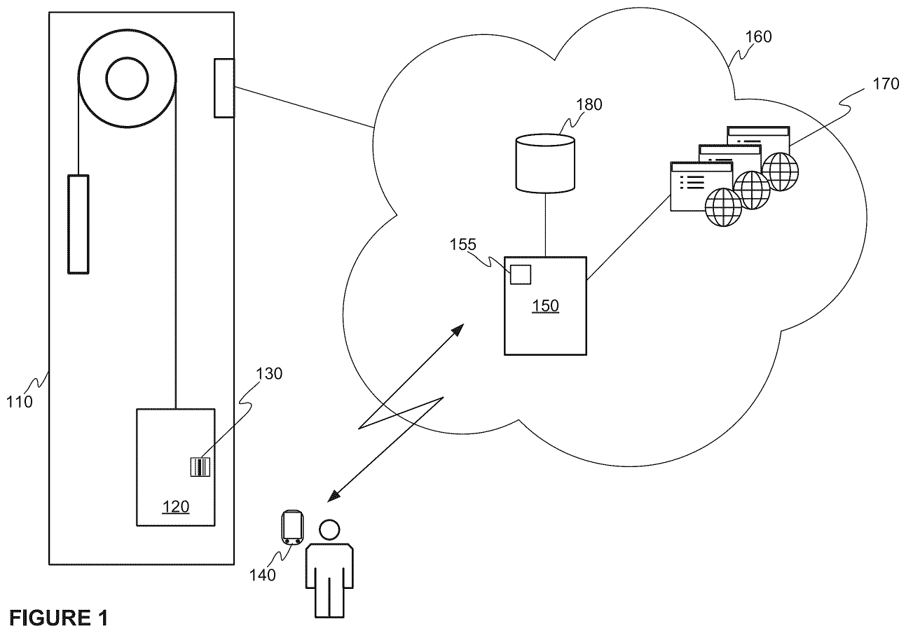

FIG. 1 illustrates schematically an environment at a system level view into which the present invention may be implemented to in accordance with at least one embodiment of the invention. The system comprises an elevator 110 as a sub-system, the elevator 110 comprising at least one elevator car 120. The elevator 110 may be provided with a linking element 130 implemented in any manner enabling an individual to utilize the linking element 130 with her/his terminal device. The utilization of the linking element 130 at least comprises reading of the data included in the linking element 130 and using the data stored in the linking element 130 in a manner as is described in the forthcoming description. The linking element 130 may be a physical entity, such as a sticker, a tag, or data visualized on a display e.g. residing in the elevator car 120. For example, a predefined coded data, e.g. in a form of a bar code or a QR code, may be used as the technology to embed the data in the linking element 130. In some other example embodiments the linking element 130 may be implemented with a device arranged to store data electronically and which may be read by applying electro-magnetic communication between the device and a reader device, cf. the terminal device 140. An example of such a device may e.g. be a RFID tag.

The system also comprises a control system 150. The control system 150 is configured to perform a method in a manner as is described in the forthcoming description. The control system 150 may be understood as a computing device configured to process data and communicate with the other entities in a manner as is described herein. For example, the control system 150 may receive data from a terminal device 140 of an individual, but possibly also from the elevator 110. The communication with the mentioned entities may be arranged by utilizing known communication technologies and communication networks. The control system 150 may reside in a data network, such as in Internet, or in a private network through the data network. Still further, the control system 150 may be arranged to be in communicative connection with a number of communication services 170 hosted e.g. by one or more different organizations. The communication services 170 may correspond to social media services, but they may also cover communication services implementable with resources of at least one mobile communication network in a manner as is described in the forthcoming description. Generally speaking, the communication service refer to a communication arrangement in which the elevator 110 is one member in at least one communication group. The concept ‘communication group’ may refer to a solution offered by the communication service 170 in question in which the users may communicate with messages that are delivered to everyone in the group. It may also refer to a solution in which the members of the group are provided with an access to see messages composed by the members of the group and shown in a service, such as in a virtual message board, accessible by the members of the group. Other solutions for forming the group for the communication may also be used as long as the elevator 110 may be included as a member of the group.

In accordance with at least some example embodiments the group in a number of communication service 170 may be established by the manufacturer of the elevator 110. The established group in the number of communication services 170 may be the elevator 110 specific in a group of elevators 110 forming an elevator system at the same location. Alternatively or in addition, it is possible to establish a communication group for the elevator system comprising a number of elevators 110. For the purpose of describing the present invention the term elevator 110 is used to cover all these options, i.e. the term also covers an elevator system consisting of one or more elevators 110. For the establishment of the group and/or association of the elevator 110 into the communication group an identifier of the elevator 110 may be used. The identifier may refer to a communication address, such as to an email address or to a phone number, by means of which the elevator system 110 may be communicatively reached. Depending on the communication service the elevator 110 may be denoted with a username descriptive on that the member in the communication service 170 is the elevator 110, for example. In other words, the elevator 110 is provided with necessary contact details as well as other information in order to establish an account for the elevator 110 in the number of communication services 170.

As already mentioned, the communication services 170 enable communication at least between the members of the communication group wherein the elevator 110 is a member of the group, either in a role of an administrator of the group or a normal member of the group. Also other profiles may be provided to the elevator 110 in the group. As non-limiting examples of the communication services 170 applicable for the purpose of the present invention may e.g. be the social media services, such as Facebook, Instagram, WeChat, and Twitter, or corresponding communication services, such as WhatsApp, Telegram, or even short message based communication group.

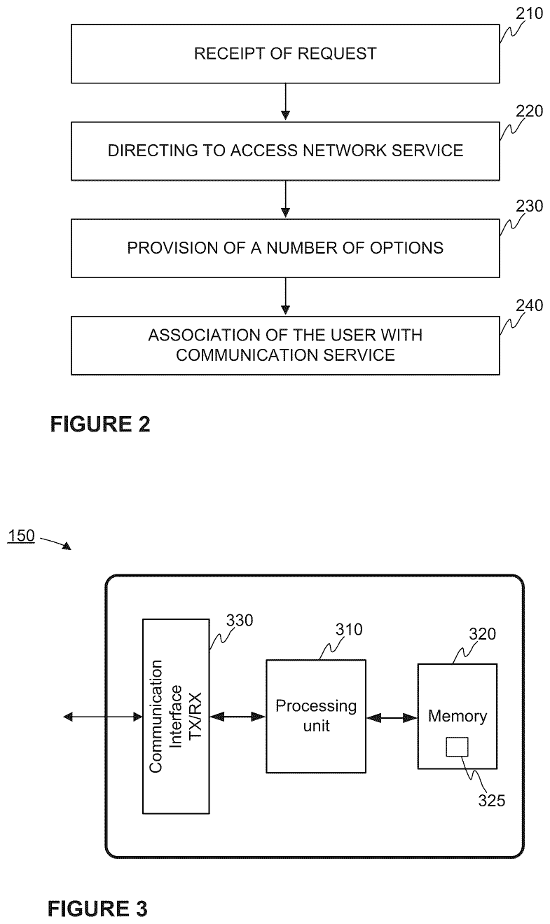

Next, aspects of the present invention are described by referring to FIG. 2 which illustrates schematically a method according to an example embodiment of the invention. The method defines a mechanism for associating a user of a terminal device 140 to a communication service 170 providing information on an operating state of an elevator 110. The information on the operating state of the elevator 110 shall be understood in a broad manner and at least to cover information the entity managing the elevator 110 is willing to deliver to the members of the communication group. Such information may e.g. relate to maintenance operations performed, or to be performed, to the elevator 110 in question, but also general information in relation to the operation of the elevator 110, such as statistical data of the operation of the elevator 110. Depending on the user rights also the individuals being members of the communication group may send messages in the communication group, such as informing the entity managing the operation of the elevator 110 on the operation of the elevator 110, such as any detected malfunction and similar.

The association of the user of the terminal device 140 is initiated by the control system 150 in response to a receipt 210 of a request from the terminal device 140. The request may carry data indicative of that an association to the communication service 170 in relation to the elevator 110 is requested. The request may e.g. be generated by the user of the terminal device 140 through an interaction with the linking element 130 arranged e.g. in the premises of the elevator 110 in any of the described ways. For example, the user of the terminal device 140 may read the linking element 130, such as a code included in the linking element 130, with her/his terminal device 140 and the reading of the data initiates a generation of the request towards the control system 150. For example, the linking element 130 may store a network address e.g. leading to the control system 150 and the request may e.g. carry an identifier of the elevator 110 from which the request is generated.

In response to the receipt 210 of the request the control system 150 may be configured to read data carried in the request. This may comprise at least that it identifies the elevator 110 from the data in the request. The identity of the elevator 110 may be embedded in, or with, the other data received in the request. In accordance with an embodiment the data in the request may define a network address descriptive of a network service in which data in relation to the respective elevator 110 is maintained and the network address defines the identity of the elevator 110. In accordance with another embodiment the control system 150 may only receive the identity of the elevator 110 in the request and determine, based on the identity, the network service 155 in which data in relation to the respective elevator 110 is maintained. As is clear from the above the network address of the control system 150 itself may be derivable from the data stored in the linking element so that the user of the terminal device 140 may communicate with the control system 150.

In response to an analysis of the data received in the request the control system 150 may be configured to direct the terminal device 140 to access a network service 155 of the elevator 110 based on the data carried in the request. The network service 155 may refer to a dedicated digital service maintained for the elevator 110 which may correspond to a webpage maintained by the control system 150, or another entity, such as a server, at least partly controllable by the control system 150. The operation of directing the terminal device 140 to access the network service 155 may refer to the determination of the network address of the network service 155 corresponding to the elevator 110 in question. The determination of the network address may be based on the identity of the elevator 110, for example, as already mentioned above. In response to the direction of the terminal device to access the network service 155 a communication session may be established so that the user may see the data output by the network service 155. Such a session may e.g. refer to a connection to the network service 155 maintained in a form of a webpage with a browser application executed in the terminal device 140.

In addition to directing the terminal device 140 to access the network service 155 of the elevator 110 the control system 150 is also configured to provide a number of options for selecting at least one communication service 170 for providing information on the operating state of the elevator 110. In other words, the network service 155 may be instructed, by the control system 150, to output, for selecting, a number of communication services 170 so that the user may perform a selection of one or more communication services 170 over which the user is willing to receive the information on the operating state of the elevator 110. The option for selection may correspond to that all communication services 170 into which an account is created for the elevator 110 and a communication group is in place are provided for selection. The control system 150 may be configured to maintain a piece of information defining the communication services 170 in a data storage 180 accessible by the control system 150. In another embodiment the control system 150 may be configured to select the communication services 170 to be output for selection by determining the communication services 170 the user has access with the terminal device 140. This may be arranged by generating an inquiry by the control system 150 towards the terminal device 140 to receive information on the communication services 170 accessible by the user of the terminal device 140. The control system 150 may receive, as a response to the inquiry, the communication services 170 usable by the user of the terminal device 140. This kind of arrangement may require that the user has allowed a delivery of the described information to the control system 150 e.g. upon the request. In response to the receipt of the data defining the communication services 170 accessible by the user of the terminal device 140 the control system 150 may be configured to provide those communication services 170 for selection to the respective user by outputting them in the network service 155. In other words, the control system 150 is arranged to define the number of options of the communication services 170 for selecting based on the information on the communication services 170 accessible by the user of the terminal device 140. The approach according to the latter embodiment has an advantage that it enables adjusting the data to be output as a user specific which improves the user experience.

Upon a receipt of one or more indications descriptive of the selection of the one or more communication services 170 over the network service 155 the control system 150 is arranged to associate 240 the user of the terminal device 140 to receive information on the operating state of the elevator through the at least one selected communication service 170. The association 240 of the user of the terminal device 140 to the at least one communication service 170 may refer to that the control system 150 is configured to manage the communication group in each of the selected communication service 170 so that the user is added as a member to the respective groups. The managing of the communication group(s) may e.g. be arranged so that the control system 150 generates a control signal comprising information on the user of the terminal device 140, such as contact details or any other pieces of information required by the respective communication services 170, and transmits it to the respective communication services 170, i.e. to data centre hosting the respective communication services 170. As a result, the user is added to a communication group of the elevator 110 in each of the communication services 170 over which the user indicated willingness to receive information on the operating state of the elevator 110.

In accordance with an embodiment of the invention it may be established measures to confirm that the user requesting the association to the at least one communication service 170 of the elevator 110 resides in the location of the elevator 110. This enhances the management of the users included in the communication group and enables preventing such individuals to access to the communication group who do not have any relation to the elevator 110 in question. Such an approach may be achieved by arranging a local communication network at the premises of the elevator 110 at least so that a network coverage of the local network is available at the locations of the one or more linking elements 130. The local network is such that the user may access to it with her/his terminal device 140 supporting a communication technology implemented by the local network. For example, the local network may e.g. be implemented with a Bluetooth technology, a Wi-Fi technology, a ZigBee technology, etc. Thus, the communication connection to the control system 150 to deliver the request to associate to the at least one communication service 170 may be arranged to be only available over the local network and, therefore, the security of the system may be improved with such an implementation. The access to the local network may be arranged to be publicly available so as to enable the users to generate the request over it.

Still further, in accordance with an embodiment the association of the user of the terminal device 140 may be implemented so that different users are provided with different access rights levels to contribute in the communication group. For example, the access right levels may be divided so that some users are only allowed to view the content in the communication group, some others may input information, such as messages, thereto, and some of the users may be assigned with administrator rights (e.g. having access to all data in the service as well as right to modify the content). The example is non-limiting and further levels may be defined. The allocation of the user to a certain group may be arranged so that the user is identified from the original request or by inquiring the identity from at least one of the communication services 170, and upon the receipt of information indicative of the identity the control system 150 may e.g. configured to perform in inquiry to a data storage 180 storing data defining access right levels for various users. Such data storage 180 may e.g. be maintained by a person being responsible of a management of the building, such as a landlord or similar, and/or the manufacturer of the elevator 110. For example, the data structure may define inhabitants of a building the elevator 110 resides to and for them e.g. an access right level allowing inputting of information in the communication group may be assigned to. Additionally, some users may be defined to administrators and their access right level is defined accordingly. The users not identifiable from the defined user groups may be provided with an access right level allowing seeing the content in the communication group, but not allowing any other way to contribute in the communication group. The information on the access right level for each user added, or to be added, in the respective communication group in the at least one communication service 170 is delivered to the respective at least one communication services 170 in order to set corresponding access right level in the service. The delivery of the information on the access right level may be delivered in the signal causing the association of the user of the terminal device 140 to access information on the operating state of the elevator 110 or it may be delivered in response to the association of the user of the terminal device 140 in the communication group.

Further aspect in relation to maintaining the data storage defining the access right levels for different users is that it may be arranged that users may be allowed to inquire a certain level of access right level e.g. through a web form. The inquiry may require an identification of the user, e.g. by applying a predefined authentication service, such as the ones based on authentication data granted by banks, and the identification may lead to a creation of a user account, or a user profile, which defines the access right levels for the further use as described.

An example of such an apparatus configurable to implement the operation of the control system 150 is schematically illustrated in FIG. 3. The control system 150 may be configured to perform the method according to the invention as described with the examples in the foregoing description. Thus, the apparatus of FIG. 3 may be configured to perform an association of a user of a terminal device 140 to at least one communication service 170 providing information on an operating state of an elevator 110. For sake of clarity, it is worthwhile to mention that the block diagram of FIG. 3 depicts some components of an entity that may be employed to implement a functionality of the apparatus. The apparatus of FIG. 3 comprises a processor 310 and a memory 320. The memory 320 may store data, such as pieces of data as described, but also computer program code 325 causing the association in the described manner. The apparatus may further comprise a communication interface 330, such as a wireless communication interface or a communication interface for wired communication, or both to communicate with other entities as described. The communication interface 330 may thus comprise one or more modems, antennas, and any other hardware and software for enabling an execution of the communication e.g. under control of the processor 310. Furthermore, I/O (input/output) components may be arranged, together with the processor 310 and a portion of the computer program code 325, to provide a user interface for receiving input from a user, such as from a technician, and/or providing output to the user of the apparatus when necessary. In particular, the user I/O components may include user input means, such as one or more keys or buttons, a keyboard, a touchscreen, or a touchpad, etc. The user I/O components may include output means, such as a loudspeaker, a display, or a touchscreen. The components of the apparatus may be communicatively connected to each other via data bus that enables transfer of data and control information between the components.

The memory 320 and at least a portion of the computer program code 325 stored therein may further be arranged, with the processor 310, to cause the apparatus to perform at least a portion of a method as is described herein. The processor 310 may be configured to read from and write to the memory 320. Although the processor 310 is depicted as a respective single component, it may be implemented as respective one or more separate processing components. Similarly, although the memory 320 is depicted as a respective single component, it may be implemented as respective one or more separate components, some, or all of which may be integrated/removable and/or may provide permanent/semi-permanent/dynamic/cached storage.

The computer program code 325 may comprise computer-executable instructions that implement functions that correspond to steps implemented in the method when loaded into the processor 310 of the respective control system 150. As an example, the computer program code 325 may include a computer program consisting of one or more sequences of one or more instructions. The processor 310 is able to load and execute the computer program by reading the one or more sequences of one or more instructions included therein from the memory 320. The one or more sequences of one or more instructions may be configured to, when executed by the processor 310, cause the apparatus, such as a computer, to perform a method as described. Hence, the apparatus may comprise at least one processor 310 and at least one memory 320 including the computer program code 325 for one or more programs, the at least one memory 320 and the computer program code 325 configured to, with the at least one processor 310, cause the apparatus implementing the control system 150 to perform the method.

The computer program code 325 may be provided e.g. a computer program product comprising at least one computer-readable non-transitory medium having the computer program code 325 stored thereon, which computer program code 325, when executed by the processor 310 causes the apparatus to perform the method. The computer-readable non-transitory medium may comprise a memory device or a record medium, such as a CD-ROM, a DVD, a Blu-ray disc, or another article of manufacture that tangibly embodies the computer program. As another example, the computer program may be provided as a signal configured to reliably transfer the computer program.

Still further, the computer program code 325 may comprise a proprietary application, such as computer program code for causing an execution of the method in the manner as described in the description herein.

Any of the programmed functions mentioned may also be performed in firmware or hardware adapted to or programmed to perform the necessary tasks.

For sake of completeness it is worthwhile to mention that the entity performing the method in the role of the control system 150 may also be implemented with a plurality of apparatuses, such as the one schematically illustrated in FIG. 3, as a distributed computing environment corresponding to a control system. For example, one of the apparatuses may be communicatively connected with the other apparatuses, and e.g. share the data of the method, to cause another apparatus to perform at least one other portion of the method. As a result, the method performed in the distributed computing environment generates the control signal indicative of the assignment of the responsibility as described.

The invention as described herein provides an improvement in an operation of elevator systems in a sense that it enables delivery of information in a communication group into which it is convenient to join.

The specific examples provided in the description given above should not be construed as limiting the applicability and/or the interpretation of the appended claims. Lists and groups of examples provided in the description given above are not exhaustive unless otherwise explicitly stated.

1. A method for associating a user of a terminal device to at least one communication service providing information on an operating state of an elevator, the method, performed by a control system, comprises:
receiving a request from the terminal device,
directing the terminal device to access a network service of the elevator defined by data carried in the request,
providing a number of options for selecting at least one communication service for providing information on the operating state of the elevator,
in response to a receipt of an indication of the at least one selected communication service associating the user of the terminal device to access information on the operating state of the elevator through the at least one selected communication service.

2. The method according to claim 1, the method further comprises a step of:
detecting, prior to directing the terminal device to access the network service, that the request is received from a communication network provided by the elevator.

3. The method according to claim 1, wherein the number of options for selecting the at least one communication service corresponds to communication services the elevator is provided with an account.

4. The method according to claim 1, the method further comprises:
inquiring, from the terminal device, information on the at least one communication service accessible by the user of the terminal device.

5. The method according to claim 4, wherein the number of options provided for selecting are defined based on the information on the at least one communication service accessible by the user of the terminal device.

6. The method according to claim 1, wherein the associating the user of the terminal device to access the information on the operating state of the elevator through the at least one selected communication service is arranged by generating a control signal to add the user of the terminal device to a group of the communication service dedicated to the elevator.

7. The method according to claim 6, wherein data descriptive of an access right level to contribute in the group of the communication service dedicated to the elevator is defined for a user of the terminal device.

8. The method according to claim 7, wherein the access right level is inquired from a data storage and delivered to the at least one communication service the user of the terminal device is associated to.

9. A control system for associating a user of a terminal device to at least one communication service providing information on an operating state of an elevator, the control system configured to:
receive a request from the terminal device,
direct the terminal device to access a network service of the elevator defined by data carried in the request,
provide a number of options for selecting at least one communication service for providing information on the operating state of the elevator,
in response to a receipt of an indication of the at least one selected communication service associate the user of the terminal device to access information on the operating state of the elevator through the at least one selected communication service.

10. The control system according to claim 9, the control system further configured to:
detect, prior to directing the terminal device to access the network service, that the request is received from a communication network provided by the elevator.

11. The control system according to claim 9, wherein the control system is configured to instruct to provide the number of options for selecting the at least one communication service to correspond to communication services the elevator is provided with an account.

12. The control system according to claim 9, the control system further configured to:
inquire, from the terminal device, information on the at least one communication service accessible by the user of the terminal device.

13. The control system according to claim 12, wherein the control system is configured to define the number of options provided for selecting based on the information on the at least one communication service accessible by the user of the terminal device.

14. The control system according to claim 9, wherein the control system is configured to arrange the associating the user of the terminal device to access the information on the operating state of the elevator through the at least one selected communication service by generating a control signal to add the user of the terminal device to a group of the communication service dedicated to the elevator.

15. The control system according to claim 14, wherein the control system is configured to define data descriptive of an access right level to contribute in the group of the communication service dedicated to the elevator for a user of the terminal device.

16. The control system according to claim 15, wherein the control system is configured to inquire the access right level from a data storage and to deliver it to the at least one communication service the user of the terminal device is associated to.

17. A non-transitory computer readable medium storing a computer program comprising instructions which, when the program is executed by a computer, cause the computer to carry out the steps of the method of claim 1.

18. The method according to claim 2, wherein the number of options for selecting the at least one communication service corresponds to communication services the elevator is provided with an account.

19. The method according to claim 2, the method further comprises: inquiring, from the terminal device, information on the at least one communication service accessible by the user of the terminal device.

20. The method according to claim 2, wherein the associating the user of the terminal device to access the information on the operating state of the elevator through the at least one selected communication service is arranged by generating a control signal to add the user of the terminal device to a group of the communication service dedicated to the elevator.
